(19) United States
(12) Patent Application Publication
(10) Pub. No.: US 2020/0216262 A1
(43) Pub. Date: Jul. 9, 2020

(54) BUFFER STORAGE SYSTEM FOR OVERHEAD CONVEYOR SYSTEMS

(71) Applicant: FERAG AG, Hinwil (CH)

(72) Inventor: Sergio SIGRIST, Hinwil (CH)

(73) Assignee: FERAG AG, Hinwil (CH)

(21) Appl. No.: 16/736,590

(22) Filed: Jan. 7, 2020

(30) Foreign Application Priority Data
Jan. 9, 2019 (CH) 00019/19

(51) Int. Cl. B65G 1/04; B65G 1/08; B65G 9/00

(52) U.S. Cl. CPC B65G 1/0457; B65G 9/006; B65G 1/08; B65G 1/0485

(57) ABSTRACT

A buffer storage device (100) for an overhead conveyor system (10) having individually conveyable transport units (40), with a closed conveying path that includes a buffer section (117) along which transport units are conveyable downstream, a feed section (104) for feeding transport units to a feed point (102) of the buffer section, a discharge section (105) for discharging transport units from a discharge point (103) of the buffer section, and one or more additional bypass sections (113) which in each case connect a starting point along the buffer section to a destination point along the buffer section.

### CROSS-REFERENCE TO RELATED APPLICATIONS

Swiss Patent Application 00019/19, filed 9 Jan. 2019, the priority document corresponding to this invention, to which a foreign priority benefit is claimed under Title 35, United States Code, Section 119, and Title 37, United States Code, Section 1.55, and its entire teachings are incorporated, by reference, into this specification.

### BACKGROUND OF THE INVENTION

### Field of the Invention

The present invention pertains to the field of transport and conveying technology. The invention relates to buffer storage devices for overhead conveyor systems having individually conveyable transport units, and overhead conveyor systems having such buffer storage devices.

### Discussion of Related Art

In logistics, in particular intralogistics, the general pressure on costs in the distribution and supply of goods is addressed, among other things, by increasing the efficiency of automated systems.

The goods stored and kept in large warehouses, in particular high rack warehouses, should, for example, be withdrawn from storage in the most efficient manner possible, combined into a group (picked), and conveyed to an intended destination. This picking, i.e., the combination of certain partial quantities (articles) from a provided total quantity (assortment) based on orders, is an important subfield of intralogistics. Dispatch centers of mail-order companies are a typical example of such applications, in which individual customer orders must be combined from a large article assortment, packaged, and sent to the recipient.

In complex production processes, once again it may be necessary to take the individual elements of the production processes, such as semifinished products, from the production facilities in question or from warehouses, and to provide these to the correct destination for further production steps in an efficient, error-free, and timely manner. The quantities of individual product elements to be kept on hand, the personnel requirements, and the size of the facility should generally be as small as possible, in particular for economic reasons. Likewise, delivery delays should be avoided in order to prevent costly interruptions or disruptions in the overall production. Highly complex production facilities in the automotive industry are a typical example of such applications, in which multiple vehicle models in a variety of equipment variants are mounted and built in stages from a very large number of individual parts.

In automated warehouses, large manufacturing plants, and in general for the conveying and transport of goods, overhead conveyor systems have proven to be an efficient means for transport, intermediate storage, and long-term storage of various types of goods and articles.

Such overhead conveyor systems typically have transport units that receive the transport good, and that are conveyed along a conveying path via the overhead conveyor system.

In overhead conveyor systems, the goods to be transported may be suitably directly or indirectly stored and conveyed on individual transport units in a suspended manner. In particular, the design of the transport units depends on the type of transport good, for example based on the geometry and/or the mass/weight.

In the present description, the term “flow of goods” is understood to mean a sequence of individual transport units containing transport goods that are linearly conveyed in succession in an overhead conveyor system in a general conveying direction.

Comparably small piece goods may be stored and conveyed in a suspended manner, for example in appropriately sized containers, in particular transport bags, on the transport unit.

Gripper devices mounted beneath the transport unit have proven suitable for printed products.

Garments that are hung on clothes hangers may be stored and conveyed in a suspended manner by hanging the clothes hanger hook in a suspension device of the transport unit.

For larger transport goods such as automotive body parts and assemblies for automotive manufacture, or individual elements for the construction industry such as doors, bathtubs, window elements, etc., the transport units typically have correspondingly large dimensions, possibly with the additional use of mobile floor plates, containers, or transport racks.

Thus, for example, International Patent application PCT/EP2018/072975, published as WO 2019/042916 A1, discloses a transport carrier for an overhead conveying device, which may be adapted for use for various transport goods. The transport carrier includes carrier elements that form at least one receiving space for receiving a transport good, the carrier elements being movable relative to one another in at least one adaptive configuration and being lockable in at least one locking configuration. In the adaptive configuration, the carrier elements are movable relative to one another in such a way that the geometry of the receiving space and/or the spatial extension of the transport carrier are/is changeable.

Overhead conveyor systems may be implemented in particular as gravity-conveyed conveyor systems in which individually movable transport units have a trolley that is equipped with wheels and that moves on corresponding guide rails. One advantageous example of such a gravity-conveyed, rail-guided conveyor system is known from US 2018/0215547 A1. The individual transport units may move on downwardly sloping conveyor lines, driven by gravity due to their intrinsic weight, without an additional drive.

To overcome horizontal or ascending line sections, the transport units may be temporarily brought into operative connection with external conveying devices. For comparably long line sections and ascending lines, in particular power and free conveyors are suited in which the individual transport units, generally the trolleys thereof, are temporarily coupled to a continuously driven conveyor chain, for example by means of a coupling bolt of the trolley that is pushed by a carrier of the conveyor chain. To end the active conveying, the transport unit is decoupled or released from the conveyor chain.

US 2018/0037413 A1 discloses an advantageous variant of a power and free conveyor that is particularly suited for essentially horizontal conveying. In this power and free conveyor, transport units, for example, may be supplied to a continuous conveyor as needed via switches, wherein the continuous conveyor forms a closed conveying path and may be coupled to the continuous conveyor. The transport units may be decoupled from the continuous conveyor and led away via switches as needed.

For comparably short conveyor lines, worm drives may also be used, in which a coupling bolt of a trolley is situated in a spirally circulating slideway of a cylinder situated in parallel to the conveying path and rotating along the longitudinal axis. The longitudinal rotation of the worm drive cylinder results in driving of the trolley, and thus of the transport unit, in the longitudinal direction of the worm drive cylinder. By a suitable selection of the pitch of the spiral slideway, the longitudinal conveying speed may be adjusted as a function of the likewise controllable rotational speed of the worm drive.

Overhead conveyor systems with individually conveyable transport units are particularly suited for efficiently conveying heterogeneous piece good articles, for example workpieces in production processes, replacement parts, and consumer goods such as books, clothing, shoes, etc. Thus, for example, overhead conveyor systems may be used in logistics centers of mail order companies for storing a plurality of articles of various sizes and weights, and for picking groups of articles according to the particular customer orders and providing them for shipment, using the same conveyor system, i.e., without changing the conveying medium.

One aspect that is relevant for overhead conveyor systems is the simple, smooth, and efficient introduction of goods into unoccupied transport units and removing the goods from the transport units. Manual filling of provided unoccupied transport units such as transport bags, or manual removal of goods from the transport bags allows flexible handling of various goods, but is slow and costly. WO 2018/142242 A1 discloses an advantageous device for automated filling of transport bags conveyed in a suspended manner. WO 2018/142243 A1 discloses an advantageous device for automated emptying of transport bags conveyed in a suspended manner.

Another important aspect in logistics facilities based on overhead conveyor systems is sorting of transport units and combining groups of transport units, for example to provide transport units with goods of a picking order, or to correctly and efficiently distribute semifinished products in a complex production chain.

A sorting facility for an overhead conveyor system having individually conveyable transport units is known from U.S. Pat. No. 5,799,800. Transport units are mounted in an unsorted sequence on a conveyor system having a closed conveying path. The transport units are guided in a selective manner on collection lines that branch off from the conveying path, and are returned to the conveying path in a suitably altered sequence, resulting in presorting. This operation is repeated over further blocks of collection lines situated downstream until the desired sequence of transport units is achieved. Such a sorting facility is used in particular as the sole, or last, sorting stage in the continuous flow of goods in picking facilities prior to distribution to the individual picking stations. Sufficiently high storage capacities are necessary for good sorting performance, for which reason the space requirements are correspondingly high.

Another functionally related sorting facility is known from US 2002/0053535 A1, in which a flow of goods of unsorted objects may be brought into a desired sequence over multiple sort runs. In a first sort run, the objects to be sorted are deposited on a plurality of parking sections of a first block. In a second sort run, the objects are transferred from the first block of parking sections to a second block of parking sections. In a third sort run, the objects are transferred from the second block of parking sections back to the first block of parking sections. Due to the sort runs connected in succession, the blocks of sorting lines may be used multiple times, as the result of which the space requirements are smaller. However, use in continuous flows of goods via batchwise processing is inefficient.

Yet another sorting facility for overhead conveyor systems is known from EP 0582224 A1. In this sorting facility, transport units from a conveying circuit are distributed over a plurality of storage circuits, which deliver the transport units back to the conveying circuit in a desired sequence. Similar sorting facilities are also known from WO 95/27672 A1, DE 20103664 U1, and WO 2013/029192 A1. The space requirements for these types of sorting facilities are comparatively high.

EP 1035047 A2 discloses an overhead conveyor system having a goods store that is made up of a plurality of storage lines situated in parallel, and that is usable as an input store for receiving goods and also as an output store for outgoing goods.

A digital printing processing system is known from WO 2018/020352 A1, in which various partial products, intermediate products, and end products of production facilities and processing plants are delivered to or received by an overhead conveyor system having a circulating conveying path. Storage devices having a large storage volume may also be connected to the overhead conveyor system, the storage devices being able to accept a plurality of elements from the overhead conveyor system and deliver them back to the overhead conveyor system at the same location, in an unaltered sequence. Thus, a sorting action cannot be efficiently achieved.

WO 2013/029192 A2 discloses an overhead conveyor system in which transport units containing transport goods are transferred batchwise from an input section into a plurality of storage circuits circulating in a circle. Transport units containing identical transport goods are stored in each case in a storage circuit. From the storage circuits, the transport units are then delivered to a linear output section. Groups of various transport goods may be combined by the selective retrieval of transport goods from the various storage circuits. The storage circuits may be designed as closed spiral conveyors, having a first horizontal conveying section in which transport units arriving from the input section may be fed, and discharged into the output section. In a subsequent second section the transport units are conveyed upwardly, against the force of gravity, via a conveying device. Lastly, in a third section they are downwardly conveyed by gravity on a spiral conveying path, and are transferred back to the first horizontal section. This longest section is used as a storage section.

International Patent application PCT/EP2018/069214, published as WO 2019/016120 A1, discloses an advantageous facility for picking goods that are transportable in a suspended manner, the facility having, among other things, an intermediate store with a continuous conveyor, via which an intermediate storage function as well as a certain presorting of the goods may be achieved. The continuous conveyor is divided into two areas. In a first area, a dynamic store is formed by a plurality of parallel storage lines that exit the conveyor line of the continuous conveyor as branches. Analogously, in a second area a retrieval store is foifined by a plurality of parallel storage lines that exit the conveyor line of the continuous conveyor as branches. The continuous conveyor is provided for transporting the goods from the dynamic store to the retrieval store.

The known sorting facilities are particularly suited for picking facilities, in which a plurality of transport goods are quickly withdrawn from a warehouse, buffered in an intermediate store to ensure a continuous flow of goods, and sorted in one or more stages in order to be subsequently conveyed as a group to appropriate output stations. The transport units to be conveyed have a comparatively small weight and volume, which allows correspondingly rapid conveying and compact storage. The corresponding logistic sequence is comparatively simple and standardizable, and the individual logistics operations in the form of picking orders to be handled are clearly demarcated in terms of time and contents.

For more complex logistic sequences such as conveying of various different semifinished products within a manufacturing plant, for example for automotive manufacturing, the known intermediate storage facilities or sorting facilities have disadvantages. On the one hand, the space requirements for the plurality of storage lines for the comparatively large transport goods such as entire automotive body parts are disproportionately greater. On the other hand, the sorting function is optimized for efficient sorting and conveying of groups of transport goods, but not for the efficient control of flows of goods, in which individual transport goods must be taken from a plurality of access locations and delivered to a plurality of destinations in the correct sequence and at the right time.

In addition, the known intermediate storage facilities or sorting facilities are less efficient in taking into account changes in the logistics operations while they are being carried out. Thus, due to failure of a subelement of the production chain, for example an assembly line as the destination for transport goods, or a production facility as the access location of transport goods, it may be necessary, for example, to adjust the conveying tasks for a short time in order to avoid or minimize a costly interruption of production. This may require resorting and changing the intermediate storage of the transport goods, which with the known facilities is complicated and less efficient.

There is a general need for improvements in this field of technology.

### SUMMARY OF THE INVENTION

The object of the invention is to provide a buffer storage device for overhead conveyor systems having individually conveyable transport units, which does not have the above-mentioned and other disadvantages. In particular, the aim is for such a buffer storage device to be able to fulfill its primary function as a buffer store, i.e., to temporarily store transport units, supplied on a conveying path in an overhead conveyor system, for subsequent reuse or further conveying, in particular in order to compensate for or to buffer temporary differences between the feed rate and the discharge rate.

Furthermore, a buffer storage device according to the invention is intended to provide a sorting functionality as a secondary function, with which the transport units that pass through the buffer storage device according to the invention may be resorted within the flow of goods.

Such a buffer store device should reduce the sorting effort downstream from the buffer storage device.

The aim is for a buffer storage device according to the invention to be suitable in particular for heavy and/or bulky transport goods, in which the maximum conveying speed of the transport units is limited due to physical reasons, and the aim in particular is also to provide an efficient sorting functionality for such transport goods.

Such a buffer storage device should be flexibly operable while still ensuring a high throughput speed. It should be easily adaptable to changing operating parameters, for example changed requirements for the throughput speed or the storage capacity, or short-term changes in the production sequence.

Such a buffer storage device should have a compact design, with preferably small space requirements and volume requirements.

Furthermore, such a buffer storage device should be buildable and operable in the most efficient and cost-effective manner possible. In particular to minimize the energy consumption, the conveying of the transport units in the buffer storage device should take place primarily by gravity.

The buffer storage device should have a low likelihood of failure in order to minimize costly down times and the associated adverse effects on the operational process of an overhead conveyor system and the overall logistics system.

These and other objects are achieved by a buffer storage device according to the invention, a buffer storage system according to the invention, and an overhead conveying device according to the invention, according to the independent claims. Further preferred embodiments are set forth in the dependent claims.

A first aspect of the invention relates to a buffer storage device for an overhead conveyor system having individually conveyable transport units. The overhead conveyor system has a closed conveying path comprising a buffer section along which transport units are conveyable downstream, a feed section for feeding transport units to a feed point of the buffer section, a discharge section for discharging transport units from a discharge point of the buffer section, and one or more additional bypass sections which in each case connect a starting point along the buffer section to a destination point along the buffer section.

Such a bypass section allows transport units to be withdrawn in a selective manner from the flow of goods on the buffer section, and to introduce the transport units in a selective manner into the flow of goods on the buffer section at another location, in order to achieve relocation of transport units in the moving flow of goods, resulting in a sorting effect.

In such a buffer storage device, a bypass section advantageously forms a return section which together with the buffer section forms a closed conveying path.

One or more bypass sections are advantageously designed as ascending sections that connect the starting point of the bypass section to a destination point of the bypass section situated upstream from the stated starting point. In the present context, the term “ascending section” is understood to mean the conveying upstream, opposite the general conveying direction of the flow of goods in the buffer store. In this way, a transport unit that is discharged into a bypass section may be shifted within the flow of goods, from its original position upstream, toward the rear. If the buffer section is descending, for example during gravity-driven conveying of the flow of goods, an ascending section requires a drive via which the transport units on the ascending section can overcome the height difference. However, the buffer section may also have an ascending design, so that gravity-driven conveying of the transport units on the ascending section is possible.

Alternatively or additionally, one or more bypass sections may advantageously be designed as drop sections that connect the starting point of the bypass section to a destination point of the bypass section situated downstream from the stated starting point. In the present context, the term “drop section” is understood to mean the conveying downstream, in the direction of the general conveying direction of the flow of goods in the buffer store. In this way, a transport unit that is discharged into a bypass section may be shifted within the flow of goods, from its original position downstream, toward the front, in that it passes a number of transport units on the drop section that were originally in front of it. However, the transport unit may also be shifted toward the rear in the flow of goods: if a transport unit on the bypass section reaches the destination point later than when on the original conveying path, a certain number of transport units originally in front of this transport unit pass the transport unit in question.

A difference in the conveying speed between the starting point and the destination point of the drop section or the corresponding section of the buffer section may be achieved, for example, by different lengths of the sections to be completed, or by different conveying speeds, for example due to different rates of inclination of the sections in gravity conveying, or due to different conveying speeds of a conveyor drive.

A buffer storage device according to the invention may have two or more feed sections for feeding transport units.

In such an embodiment of the buffer store device, it is particularly advantageous for two or more feed sections to discharge into the buffer section at two or more feed points. Such a configuration already allows a certain presorting due to the fact that the feeding of the transport units from the various feed sections does not take place randomly, but, rather, in such a way that a certain placement in the flow of goods is achieved.

A buffer storage device according to the invention may also have two or more discharge sections for discharging transport units.

In such an embodiment of the buffer store device, it is particularly advantageous for two or more discharge sections to branch off from the buffer section at two or more discharge points. Such a configuration allows compaction of the transport units on the buffer section after a discharge point, since at that location in each case a portion of the flow of goods is withdrawn and led away on the downstream discharge section.

For a buffer storage device according to the invention, the entire buffer section or a portion of the buffer section advantageously has a downward slope.

For a buffer storage device according to the invention, the transport units are advantageously conveyable by the force of gravity along the entire buffer section or a portion of the buffer section.

For a buffer storage device according to the invention, the transport units are advantageously conveyable by a drive, for example a power and free conveyor or a circulating conveyor, on the entire buffer section or a portion of the buffer section.

The entire buffer section or a portion of the buffer section of a buffer storage device according to the invention may have the form of a downwardly leading conveying path. Such a downwardly leading conveying path may be designed as a downwardly sloping spiral, for example, to make maximum use of the volume.

In one advantageous embodiment of a buffer storage device according to the invention, one or more accumulation points at which transport units may be accumulated and released in a selective manner are provided along the buffer section. In this way, for example the effective conveying speed on a downwardly sloping buffer section may be controlled in such a way that transport elements may be fed from a bypass section at the correct location in the flow of goods.

A storage ring device may be provided along the conveying path of a buffer storage device according to the invention, which can take transport units from the buffer storage device at a transfer point and store them, then withdraw them and transfer them to the transfer point at the buffer storage device. Such a storage ring device corresponds essentially to a bypass section in which the starting point and the destination point are identical along the conveying path.

A buffer storage device according to the invention having such a storage ring device has the advantage in particular that groups of transport units may be temporarily withdrawn from the flow of goods of the buffer store without having to be promptly fed back in. The storage capacity of a buffer storage device according to the invention may also be increased by the capacity of the storage ring by guiding the flow of goods, arriving at the transfer point on the conveying path of the buffer section, in a loop through the ring store and subsequently back to the buffer section via the transfer point downstream.

In addition, a sorting device may be provided along the conveying path of a buffer storage device according to the invention, which can take transport units from the buffer storage device, sort them, and transfer them back to the buffer storage device in an altered sequence.

In complex overhead conveyor systems, it may be necessary to be able to quickly and efficiently determine or monitor the spatial location of individual or all transport units or their transport goods.

A buffer storage device according to the invention advantageously has a locating system, for example a radio-based locating system, with which the location of transport units and/or transport goods within the buffer storage device may be determined.

International Patent application PCT/EP2018/072979, published as WO 2019/042918 A1, discloses a suitable system for this purpose, in which the spatial position of transport units and/or transport goods within an overhead conveyor system may be determined by radio frequency-assisted means, for example radiolocation.

A buffer storage device according to the invention may have a monitoring system with one or more sensor units situated along the conveying path, via which data of data carrier elements of passing transport units and/or passing transport goods may be received.

Such an embodiment has the advantage that the passing of individual transport units or transport goods at checkpoints along the conveying path may be recorded and continuously compared to a setpoint state. In this way, it is possible for deviations from the setpoint state to be rapidly detectable during operation of the buffer storage device. Such deviations may be caused, for example, by malfunctions of individual elements, such as blocked switch elements. Such malfunctions may thus be identified or limited very quickly so that repairs may be initiated. At the same time, the operation of the facility may be adapted to the instantaneous state of the buffer storage device, for example by taking a malfunctioning element of the control device into account in the control of the buffer storage device.

A second aspect of the invention relates to an advantageous buffer storage system having two or more buffer storage devices according to the invention, connected in parallel.

Such a buffer storage system allows a disproportionate increase in the storage capacity compared to a buffer storage system having only one buffer storage device. By suitable arrangement of the conveying paths of the two buffer storage devices, better use may be made of the spatial volume, thus improving the ratio of the attainable storage capacity to the volume requirements and/or space requirements.

In one advantageous variant of such a buffer storage system, connecting sections are provided between two or more buffer storage devices that are connected in parallel, such that transport units can change from one buffer storage device to another buffer storage device, via said connecting sections. Thus, from a functional standpoint, line sections of one buffer storage device may be used as bypass sections of another buffer storage device, and vice versa. Such a buffer storage system allows very flexible sorting functionalities in the continuous flow of goods.

A third aspect of the invention relates to an advantageous overhead conveyor system having a buffer storage device according to the invention or a buffer storage system according to the invention.

In an overhead conveyor system according to the invention, a sorting device may be situated downstream from the buffer storage device according to the invention or the buffer storage system according to the invention. With presorting in the flow of the transport units via a buffer storage device according to the invention while passing through the buffer store, it is possible, among other things, to operate such a downstream sorting device more efficiently or dimension it to be smaller.

A fourth aspect of the invention relates to a transport unit for an overhead conveyor system, which is provided for receiving a plurality of transport goods, in particular bottles, spray cans, and other containers, which at one longitudinal end have a protrusion that may be gripped underneath by suitable holding means.

Such an advantageous transport unit includes a trolley with which the transport unit is conveyable in an overhead conveyor system, and a carrier device.

The carrier device is particularly advantageously situated beneath the trolley in the operating position of the transport unit.

The carrier device advantageously has at least one carrier channel in the form of an undercut hollow profile that is open at the bottom.

The carrier channel or the hollow profile may have a one-part design, or may be assembled from multiple parts.

The carrier channel of the carrier device is oriented essentially horizontally in the operating position of the transport unit. The operating position of the transport unit is understood to mean the position of the transport unit which it assumes on a horizontal section of a running rail of an overhead conveyor system.

The above-mentioned transport unit advantageously has a first coupling device that couples the carrier device to the trolley, and that ensures an essentially horizontal orientation of the carrier device or the carrier channel when the transport unit is situated on a nonhorizontal section of a running rail of an overhead conveyor system. This allows loaded transport units to overcome upward and downward slopes up to a certain maximum value without impairing the functioning of the carrier device.

For example, such a first coupling device may have an articulated joint, so that the carrier device is pivotably connected to the trolley, and due to its intrinsic weight always automatically assumes the desired horizontal orientation.

Many containers, such as bottles or spray cans and the like, have a circumferential collar in the opening area. The undercut channel of a transport unit, which is open at the bottom, allows the suspended bearing of such containers, in that the protrusion rests on the projections of the undercut hollow profile. For this purpose, the upper area of the containers with the protrusion is inserted into the carrier channel through an open longitudinal end of the carrier channel.

The carrier channel of the carrier device of such a transport unit is advantageously situated perpendicularly with respect to the conveying direction of the transport unit. This allows in particular automated loading of the transport unit by insertion of containers into the carrier channel from the side, perpendicularly with respect to the conveying direction, preferably using a loading device. In addition, in such a configuration the transport units may be accumulated in succession in the overhead conveyor system with maximum compaction.

Such a transport unit particularly advantageously has a second coupling device that couples the carrier device to the trolley, and that allows the orientation of the carrier channel of the carrier device to change in relation to the conveying direction of the transport unit, for example by rotation about the vertical. This allows the orientation of the carrier device to be set differently, depending on the operating mode. For example, in a transport mode of the carrier device the carrier channel may be oriented perpendicularly with respect to the conveying direction of the transport unit, in a loading mode of the carrier device may be oriented at an angle of 45° with respect to the conveying direction, and in an unloading mode of the carrier device may be oriented in parallel to the conveying direction.

For example, such a second coupling device may have rotatable hanger mechanisms as disclosed in WO 2018/142242 A1, for example, with which a carrier device may be mounted in a suspended manner on a trolley in multiple stable positions.

Such an advantageous transport unit advantageously has two or more carrier channels situated adjacently and in parallel on a horizontal plane. This allows the transport capacity of the transport unit to be maximized.

In one advantageous variant of such a transport unit, the projections that form the undercuts of the carrier channel are made of a material with a low dynamic friction coefficient, such as HDPE or PTFE. This facilitates, for example, introduction of transport goods into the carrier device by sliding, in that the protrusions of the transport goods may slide on the projections of the carrier channel.

In an alternative variant of such a transport unit, the projections that form the undercuts of the carrier channel are made of a material with a high static friction coefficient, such as a rubber-like material. In such a variant, the transport goods are introduced into the carrier device without the protrusions of the transport goods contacting the projections of the carrier channel. After reaching the setpoint position, the transport good is lowered vertically, for example, so that the protrusion now remains on the projections of the carrier channel and is fixed in the horizontal direction by frictional engagement.

In one particularly advantageous variant of such a transport unit, an opening at one longitudinal end of the carrier channel may be reversibly closed by a closure element, for example a spring element. The opening at the other longitudinal end may be permanently, or likewise reversibly, closed. In this configuration, the containers are temporarily held in the carrier channel in a form-fit manner, and may be securely transported via the transport unit.

### BRIEF DESCRIPTION OF SEVERAL VIEWS OF THE DRAWINGS

In order to facilitate a fuller understanding of the present invention, reference is made below to the appended drawings. The drawings show embodiments of the inventive subject matter strictly by way of example. Identical or functionally equivalent parts in the figures and the associated description are provided with the same or similar reference numerals.

FIG. 1 schematically shows a first possible embodiment of a buffer storage device according to the invention;

FIG. 2 schematically shows a second possible embodiment of a buffer storage device according to the invention;

FIG. 3 schematically shows a third possible embodiment of a buffer storage device according to the invention;

FIG. 4 schematically shows a fourth possible embodiment of a buffer storage device according to the invention;

FIG. 5 schematically shows one possible embodiment of a suspended storage system according to the invention having three parallel buffer storage devices according to the invention;

FIG. 6a schematically shows an example of an advantageous transport unit in the form of a suspended conveyor bag, in an open state, which may be used in a buffer storage device according to the invention;

FIG. 6b schematically shows the suspended conveyor bag of FIG. 6a, in a loaded state;

FIG. 7 schematically shows another example of an advantageous transport unit in the form of a transport carrier, which may be used in a buffer storage device according to the invention;

FIG. 8 schematically shows another example of an advantageous transport unit for the suspended transport of a plurality of transport goods, which may be used in a buffer storage device according to the invention;

FIG. 9a schematically shows the transport unit from FIG. 8 in the loaded state, in an oblique perspective view from below, with portions of the transport goods not shown;

FIG. 9b schematically shows the transport unit from FIG. 8 in the loaded state in a side view perpendicular to the conveying direction;

FIG. 9c schematically shows in a front view in the conveying direction; and

FIG. 10 schematically shows the transport unit from FIG. 8, being partially loaded and with opened closure element.

### DETAILED DESCRIPTION OF THE INVENTION

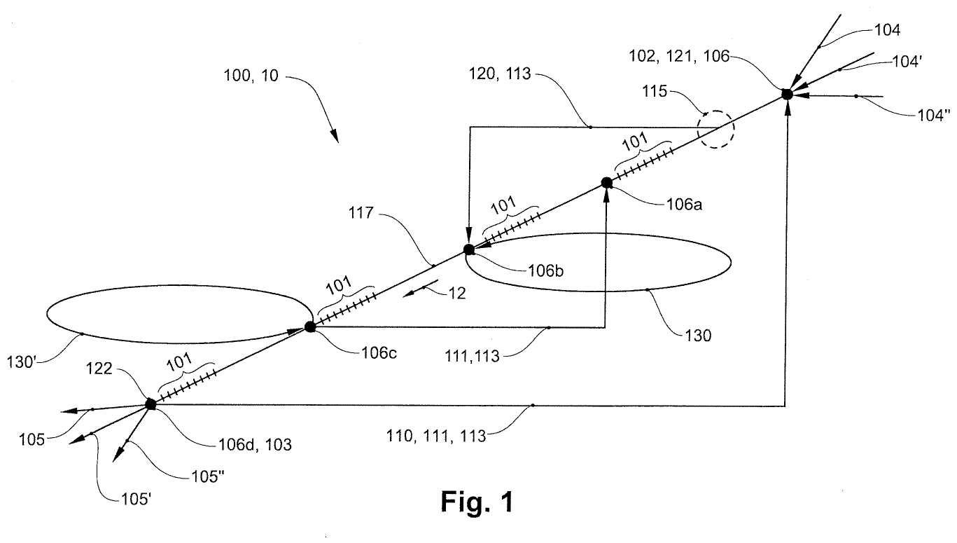

One possible embodiment variant of a buffer storage device 100 according to the invention for an overhead conveyor system 10 having individually conveyable transport units is illustrated strictly schematically in FIG. 1. A buffer section 117 extends downwardly from a starting point 121 of the buffer section to an end point 122 of the buffer section. Transport units can move downstream, driven by gravity, on the downwardly sloping buffer section along the conveying direction 12.

A bypass section 113 in the form of a return section 110 leads from the end point 122 of the buffer section 117 back to the starting point 102 of the buffer section 117, and together with the buffer section 117 forms a closed conveying path.

In the exemplary embodiment shown, multiple feed sections 104, 104′, 104″ come together at a feed point 102, which in this case is identical to the starting point 121 of the buffer section; transport units may be supplied to the feed sections from various sources. For example, in a storage facility, transport goods may be removed, and supplied to the buffer storage device 100 by means of the transport units via a feed section. Likewise, in various production facilities, semifinished products, components, etc., may be loaded onto transport units and supplied to the buffer store 100 via a feed section.

Multiple discharge sections 105, 105′, 105″ branch off at a discharge point 103, which in this case is identical to the end point 122 of the buffer section 117; transport units may be further conveyed on these discharge sections to various destinations, for example to production facilities, output points, and further subsystems of the overhead conveyor system such as sorting devices, etc.

Downstream from the starting point 121 of the buffer section 117, a bypass section 113, which in the example shown is designed as a drop section 120, branches off from the buffer section and opens into the buffer section. The discharge of transport units to the bypass section 113 at the starting point of the bypass section takes place via a suitable switch device 115. Analogously, the feeding of a transport unit back to the buffer section at the destination point of the bypass section takes place via a suitable switch device.

The technical configuration of the switch devices is a function of the specific design of the overhead conveyor system 10. Such switch devices for specific overhead conveyor systems are known to those skilled in the art.

Situated upstream from the destination point of the bypass section, at which the bypass section 113 opens into the buffer section 117, is an accumulation point 106b, behind which an upstream accumulation section 101 is situated on the buffer section. Provided at the accumulation point is a blocking device that reversibly prevents further movement of the transport units by gravity, for example by temporarily blocking a trolley of the transport unit in a form-fit manner. This may be achieved, for example, with an appropriately controlled separating device.

Due to the temporary blocking of the conveying path, further transport units run up against the blocked transport unit and are held back on the accumulation section 101. When the blocking device releases the transport unit, it once again moves downstream by gravity along the conveying direction 12.

The blocking device, which ensures a sufficient running clearance on the buffer section between the previously accumulated transport units, is advantageously designed as a separating device.

The purpose, among others, of the various accumulation points 106, 106a, 106b, 106c, 106d in the shown exemplary embodiment of a buffer section 117 is to control the feed of transport units from a bypass section into the buffer section. Only when a transport unit is inserted at the correct location in the flow of goods does the blocking device release the flow of goods at the accumulation point. In addition, the accumulation points may be used to increase the storage capacity of the buffer storage device according to the invention, since the effective conveying speed is reduced, and thus the effective density of the transport units over the entire buffer section is increased.

Provided on the buffer section 117 is a further bypass section 113 in the form of an ascending section 111, which branches off from the buffer section 117 at a starting point beneath the accumulation point 106c, and upstream opens into the buffer section 117 at a destination point beneath an accumulation point 106a. With this ascending section 113 it is thus possible to insert upstream transport units back into the flow of goods in a selective manner.

In the exemplary embodiment shown, also provided at two locations along the buffer section 117 are storage rings 130, 130′ which may receive transport units from the flow of goods and deliver them back to the flow of goods. The storage rings 130, 130′ correspond to bypass sections in which the starting point and the destination point coincide. Various storage rings 130, 130′ for overhead conveyor systems are known which may be used in a buffer storage device according to the invention.

Provided above the destination points of the storage rings 130, 130′ is an accumulation point 106b, 106c, respectively, at which the flow of goods may be stopped as needed in order to insert a transport unit from the storage ring in question into the flow of goods.

The storage rings 130, 130′ may also be used as an auxiliary loop, based on the first in, first out principle, for variably expanding the buffer section, for example by introducing the complete flow of goods into the storage ring, and at the same time continuously emptying the contents of the storage ring from the ring store and returning them downstream to the buffer section in an unaltered sequence. Depending on the conveying frequency, the transport units may be introduced into the storage ring or removed therefrom, individually or in groups. When the expansion of the buffer section is no longer needed, the arriving transport units are held back at the accumulation point until the storage ring is completely empty, and are subsequently released.

Analogously, bypass sections designed as drop sections 120 may be used to temporarily shorten the buffer section by diverting the entire flow of goods via the bypass section in question.

A temporary change in the effective length, and thus the capacity, of the buffer section as proposed above may be advantageous in particular when major changes in the production sequence require considerable rearrangements in the composition of the continuous flow of goods, for example due to a breakdown on a production line.

It may also be useful to adjust the capacity of the buffer section, for example when the capacity of a production facility changes significantly. Mentioned as an example is the changeover of a production facility from daytime production mode to a nighttime production mode, when fewer personnel are used and therefore the production rate is greatly reduced. The supplying of components via the buffer storage device is correspondingly reduced. The buffer storage device may be adapted to the lower capacity requirement by deactivating an expansion of the buffer section that is achieved with a storage ring.

Efficient sorting requires sufficient capacities, since a sorting operation may often be inefficient close to the capacity limit of a sorting system. At the same time, for a buffer storage device according to the invention the storage capacity during normal operation should not be too high, since this increases the volume requirements of the facility without added value for the sorting function according to the invention. However, by changing the effective buffer section as needed, a buffer storage device according to the invention may more efficiently adapt the flow of goods to the changed circumstances, and for example temporarily process larger sorting volumes in an efficient manner.

The buffer storage device described above has the advantage in particular that the transport units on the buffer section and the bypass sections designed as drop sections are conveyable by gravity without active drive systems. The energy requirements during operation are correspondingly minimized.

For the line sections designed as ascending sections, the conveying means, which are generally implemented as continuous conveyor chains, do not have to run continuously, but rather may be activated as needed. Even during continuous operation, the energy consumption is comparatively low, since the ascending sections accept a small proportion compared to the overall line of the buffer storage device. This applies in particular when in a closed conveying path the slope of the ascending sections is selected to be much greater than the gradient of the downwardly sloping buffer sections.

The storage rings may likewise be implemented in such a way that instead of a horizontal continuous conveyor, a drop section is connected to an ascending section.

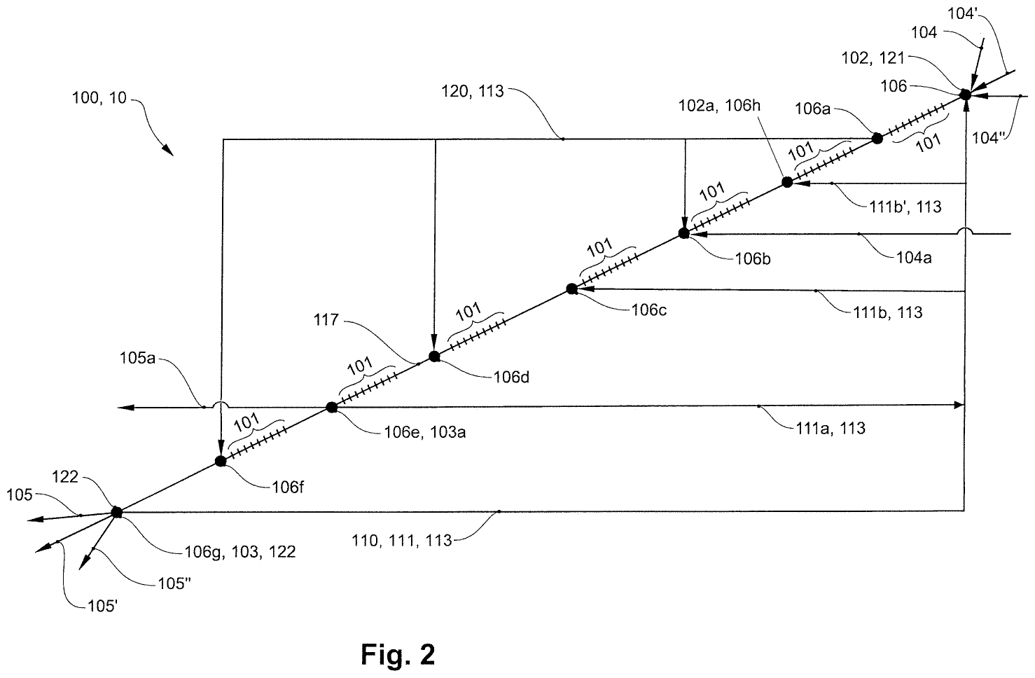

FIG. 2 shows another schematic example of a buffer storage device 100 according to the invention in an overhead conveyor system 10. A buffer section 117, the same as in the preceding example, runs on a downward slope from a starting point 121 of the buffer section to an end point 122 of the buffer section, and a bypass section 113 in the form of a return section 110 leads from the end point 122 back to the starting point 102. Multiple feed sections 104, 104′, 104″ open into the buffer section 117 of the buffer storage device 100 at a feed point 102 that is identical to the starting point 121 of the buffer section. Multiple discharge sections 105, 105′, 105″ branch off from the buffer section 117 at a discharge point 103 that is identical to the end point 122 of the buffer section 117.

In addition, a further feed section 104a opens into the buffer section 117 farther downstream at a feed point 102a beneath an accumulation point 106b. A sorting effect may be achieved merely by such a placement of the feed point.

A further discharge section 105a likewise branches off from the buffer section at a discharge point 103a within the buffer section 117. In this case as well, a sorting effect may thus be achieved.

A bypass section 113 in the form of a drop section 120 branches off from the buffer section 117 at the accumulation point 106a. The bypass section later splits into multiple branches, and opens into the buffer section at three different destination points, namely, the accumulation points 106b, 106d, and 106f. Thus, it is possible not only for such a bypass section 113 to insert a transport unit back into the flow of goods at a certain location on the buffer section, but also to do this at the best suitable location in a flexible manner, depending on the requirements. For example, the destination point for each transport unit discharged onto the bypass section 113 may be selected in such a way that the flow of goods is least restricted.

The bypass section 113 designed as a return section 110 likewise branches off. A first branch of the ascending section 111 opens into the buffer section at the accumulation point 106 at the starting point 102 of the buffer section. Two other branches 111b, 111b′ of the ascending section 111 open into the buffer section 117 downstream at the accumulation points 106h and 106c. In addition, a bypass section 113 in the form of a subsection 11 la branches off from the buffer section 117 at the accumulation point 106, and opens into the first ascending section 111. Such a system of ascending sections allows very flexible movement of transport units to other locations upstream in the flow of goods.

In one generalized embodiment variant of a buffer storage device according to the invention, multiple drop sections or ascending sections branch off from the buffer section at various starting points and open into the buffer section at various destination points. Individual line sections of the drop sections or ascending sections advantageously coincide.

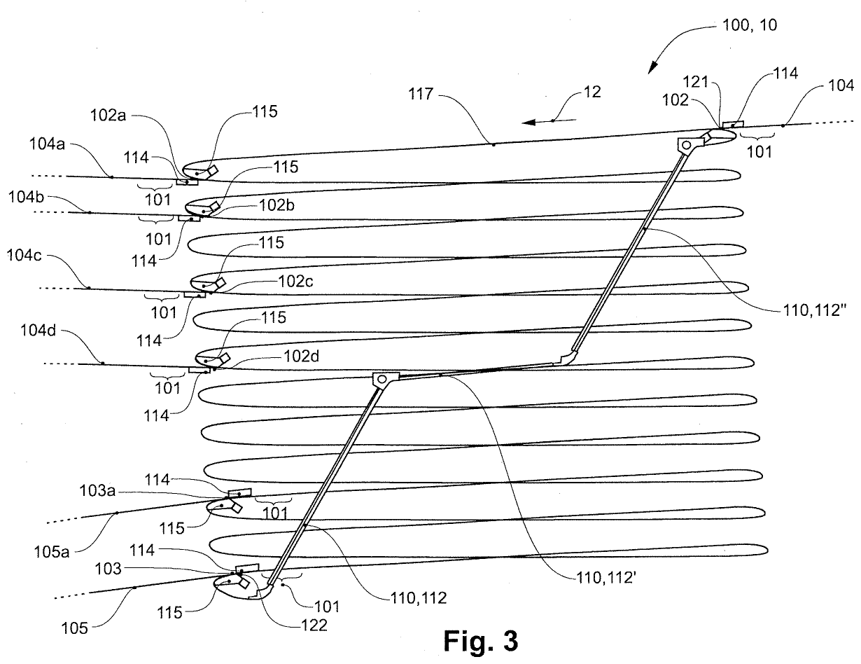

FIG. 3 illustrates yet another exemplary embodiment of a buffer storage device 110 according to the invention. The buffer section 117 has the shape of a flat spiral that leads continuously downwardly from a starting point 102 along a conveying direction to an end point 103 situated at a lower level. From there, a return section as an ascending section leads back to the starting point 102 of the buffer section 117.

In the exemplary embodiment shown, the return section 110 has three inclined conveying devices 112, 112′, 112″, having different pitch angles, situated in succession. Such a subdivision of the ascending section has the advantage that the load and the energy consumption for the inclined conveying devices are less.

A first feed section 104 opens into the buffer section 117 at the starting point 102. Four additional feed sections 104a, 104b, 104c, 104d open into the buffer section 117 of the buffer storage device 110 farther downstream at the feed points 102a, 102b, 102c, 102d, respectively. A first discharge section 105 branches off from the buffer section 117 at the discharge point 103. Another discharge section 105a branches off from the buffer section farther upstream at a discharge point 103a.

Suitable switch devices 115, only schematically illustrated, are provided at the points at which the feed sections 103, 104a-104d or the return section 110 open(s) into the buffer section 117, or at which the discharge sections 105, 105a branch off from the buffer section 117. Separating devices 114, likewise only schematically illustrated, accumulate the flow of goods on the line on which they are situated, and thus ensure correct operation of the switch devices 115, in that in particular they release transport units only individually for further transport and prevent collisions of transport units.

Such a combination of multiple feed sections and discharge sections allows a sorting function of the buffer storage device 110 according to the invention, in that the supplied transport units may be inserted into the continuous flow of goods at the desired location.

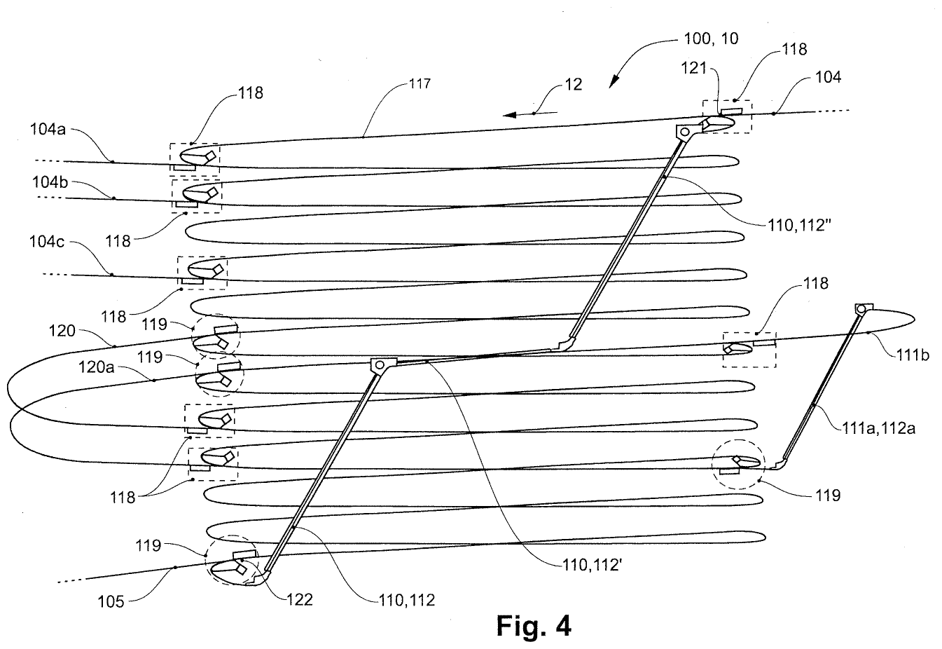

FIG. 4 shows a variant of such a buffer storage device 110 according to the invention. Junctions 118 of conveying paths are marked with dashed-line rectangles in this figure. Branches 119 of conveying paths are marked with dashed-line circles. The buffer storage device 110 has only one discharge section 105.

Two bypass sections implemented as drop sections 120, 120a branch off from the buffer section 117 at two loop end points of the buffer section 117, and in each case two windings of the buffer section 117 open into the buffer section 117 at a lower level.

Another bypass section branches off at a loop of the buffer section 117, and on a first ascending section 111a overcomes a certain height difference by means of an inclined conveying device before it merges into a downwardly sloping line section 111b, and lastly, opens into the buffer section 117 three loops above the starting point.

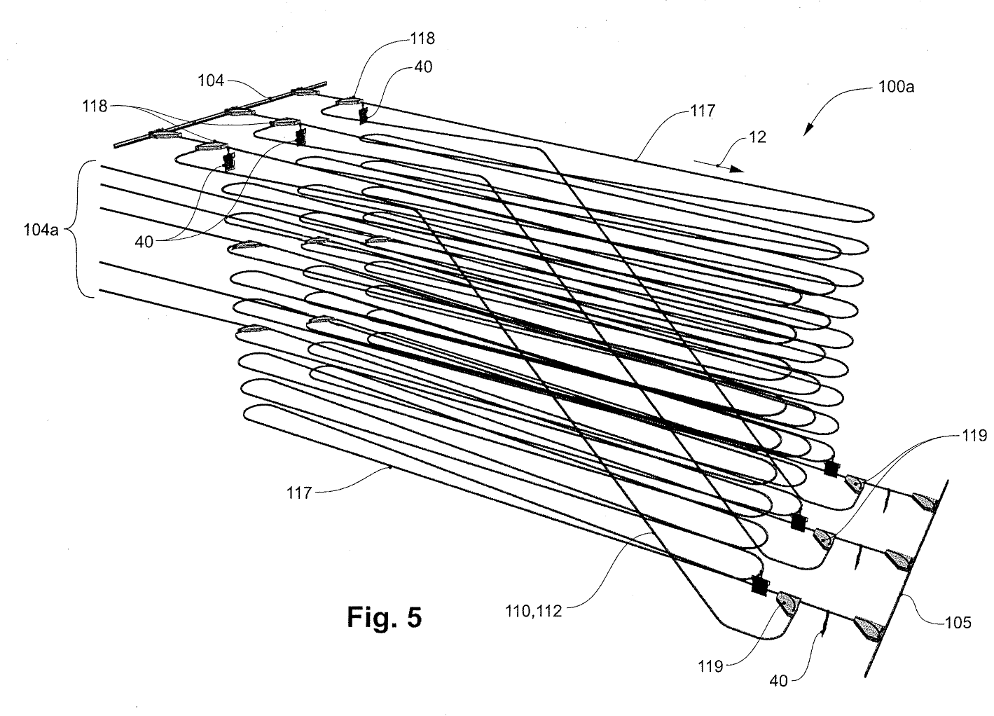

FIG. 5 shows an example of a buffer storage system 100a according to the invention. Three buffer storage devices similar to those from FIGS. 3 and 4 are adjacently situated. Transport units 40, transport bags in the example shown, reach the buffer sections 117 of the three buffer storage devices of the buffer storage system, connected in parallel, via a shared feed section 104. At the end point of the buffer sections, the transport units 40 leave the buffer storage system 100a on a shared discharge section 105. A plurality of further feed sections 104a open into the buffer sections at various locations on the three buffer storage devices.

Such a buffer storage system has a very high storage capacity per unit volume, and occupies a very small base area. The base area may even be used for other purposes, since the buffer storage system requires no facility parts on the floor and may be operated overhead.

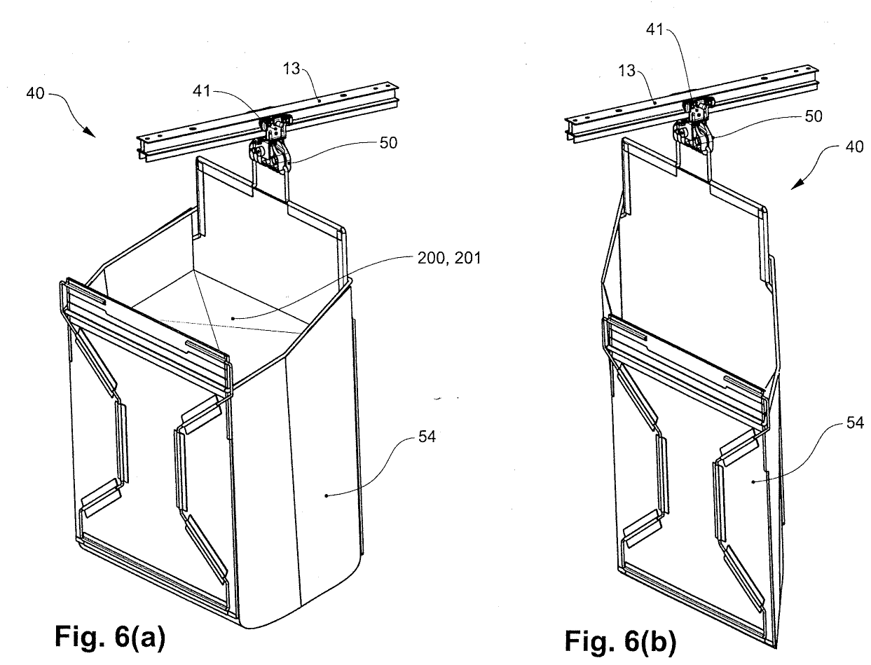

FIG. 6 shows an example of a transport unit 40 that may be used in a buffer storage device according to the invention or in a buffer storage system according to the invention. A trolley 41 of the transport unit 40 runs on a running rail 13 of an overhead conveyor system. Facing away from the running rail 13, a coupling device 50 is mounted on the trolley 41, and a transport bag 54 in turn is pivotably suspended on the coupling device. The transport bag 54 is constructed in such a way that in the empty state it automatically folds up along provided hinge elements due to its intrinsic weight, so that the transport units in the empty state (see FIG. 6b) may be accumulated or held in a space-saving manner. In the loaded state (see FIG. 6a), the transport good 200 in the form of a piece good unit, for example a package, is situated within the now folded-out transport bag 54.

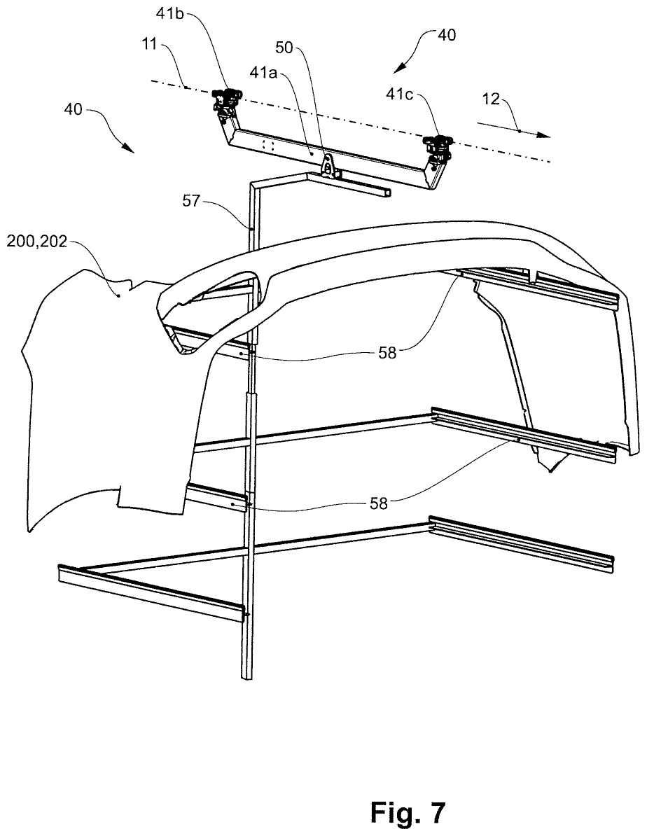

FIG. 7 illustrates another example of a transport unit 40 that is suitable for comparably large transport goods 200 such as automotive body parts 202. The transport unit 40 has two trolley elements 41b, 41c that are connected to one another via a strut 41a, and thus together form a trolley. This trolley runs on a running rail (not illustrated) along a conveying path 11 in the running direction 12. A transport carrier 57 is stored in a suspended manner on the trolley via a coupling device 50 that is pivotably connected to the strut 41a. The transport carrier 57 has multiple carrier elements 58 on which an automotive body part 202 is stored.

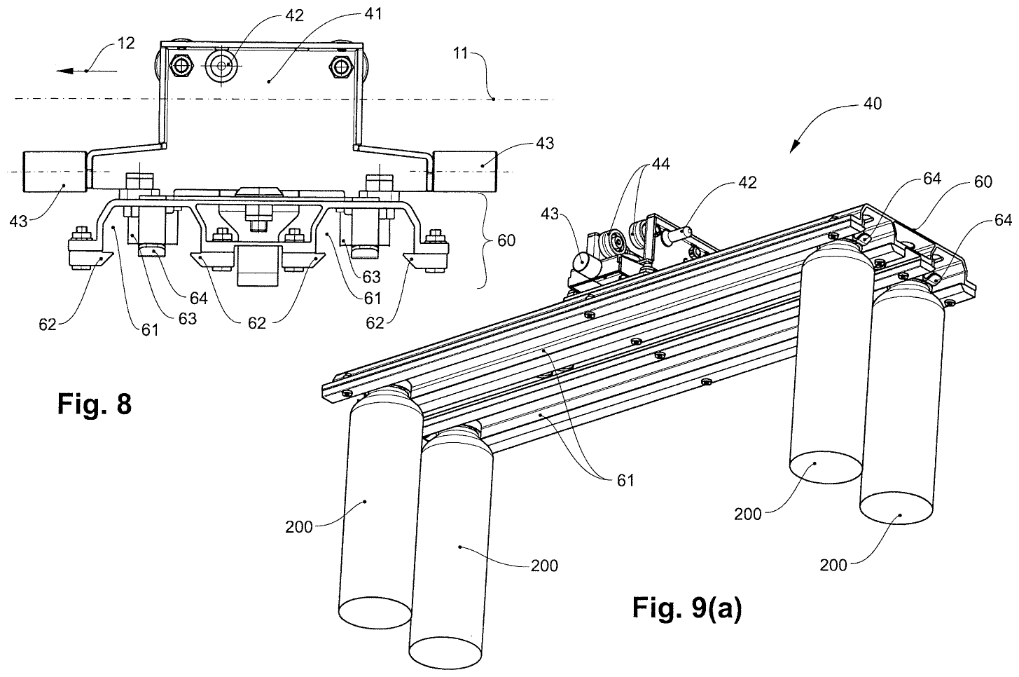

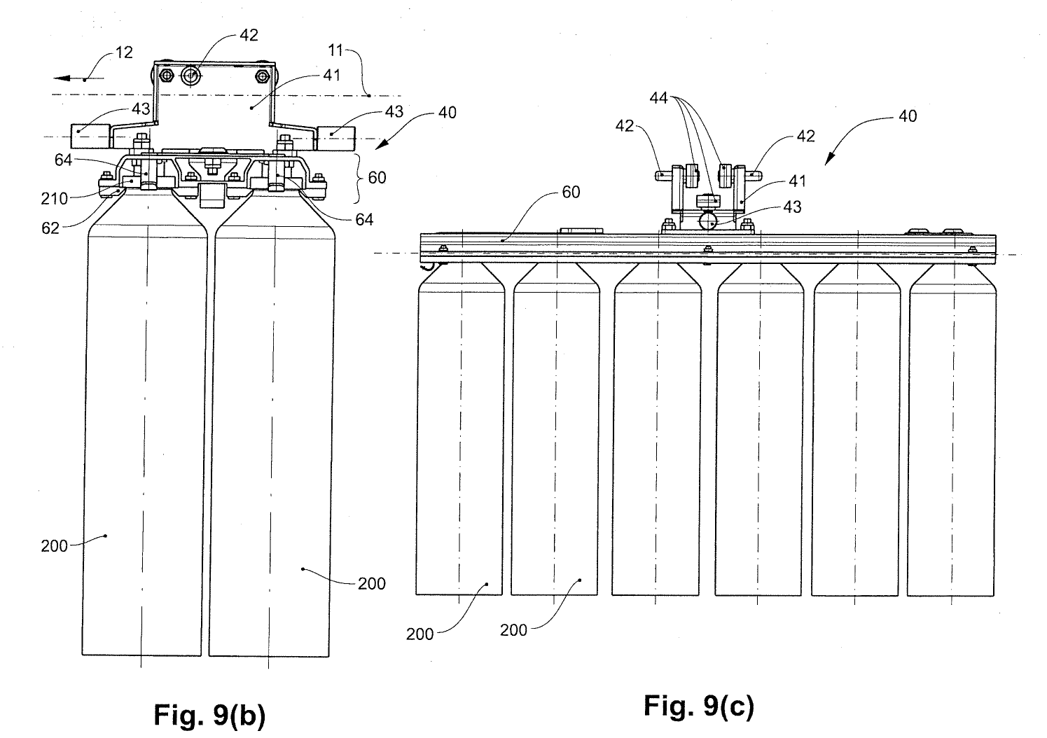

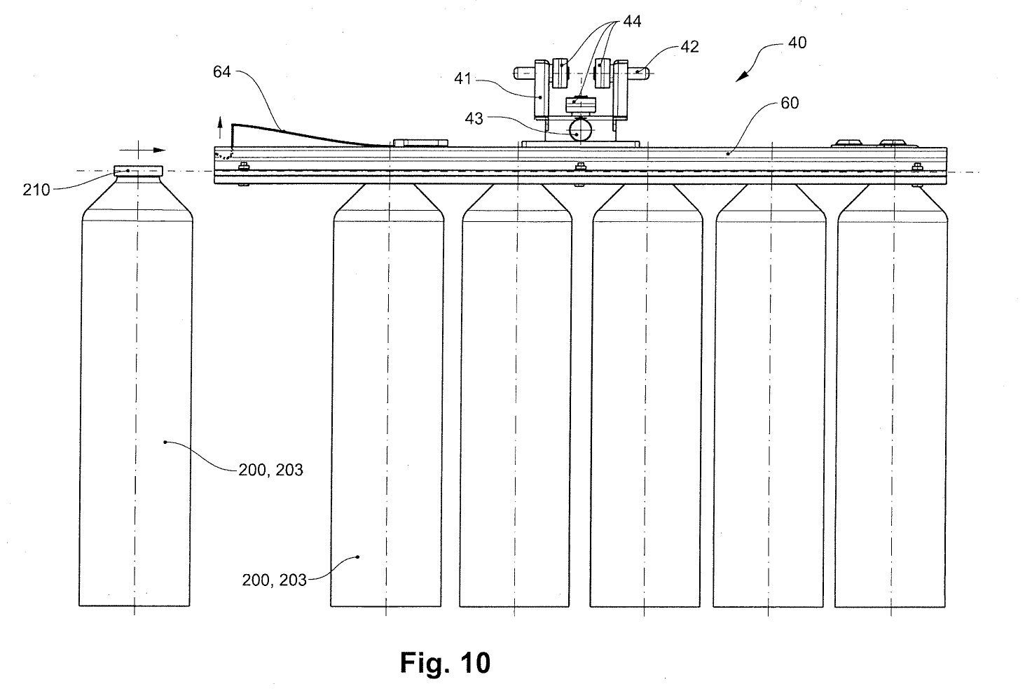

FIGS. 8, 9, and 10 show a particularly advantageous transport unit 40. The transport unit 40 has a trolley 41 similar to the one in FIG. 6, with rollers 44 that are provided to give rolling support to the trolley in the running rail (not illustrated) and to hold the trolley laterally in the track. A coupling bolt 42 allows reversible coupling of the trolley 41 to a conveying means (not illustrated), for example an inclined conveyor, a continuous conveyor, or a screw conveyor.

A carrier device 60 that is suitable for storing in a suspended manner or transporting a plurality of bottles (in the present case, twelve bottles) or similar containers is situated below the trolley.

The trolley 41 has a spacer 43 on both sides in the running direction 12, which ensures a sufficient distance from the preceding and following transport unit during compacted storage or during loading of the transport unit 40 when transport units are accumulated on the conveying path, thus preventing undesirable contact of the carrier devices 60 or the transport good. The spacers may also be used as shock absorber elements, in that they are made of an elastomer, for example, and/or have a spring element.

A carrier device 60 is situated below the trolley 41, transverse to the running direction 12, and in the exemplary embodiment shown is fixedly connected to the trolley. This orientation of the carrier device in relation to the trolley allows a compacted arrangement of the transport units on the conveying path.

Alternatively, a connection by means of a coupling device is also possible which, for example, allows rotation of the carrier device with respect to the trolley. For example, such a coupling device may be designed as an articulated element that allows a swivel motion about a horizontal rotational axis transverse to the conveying direction. The carrier device stored in a suspended manner on the articulated joint thus remains horizontally oriented on nonhorizontal sections of a conveying path. Such a transport unit is also suited for the buffer storage devices described above.

Alternatively or additionally, the coupling device may allow rotation of the carrier device about a vertical rotational axis, which allows the orientation of the carrier device to be changed in relation to the running direction.

The carrier device 60 has two parallel carrier channels 61. Each carrier channel 61 has two projections 62.

In the example shown in FIGS. 8, 9, and 10, the transport goods 200 to be transported are bottle-like containers 203 that have a circumferential collar 210 in the area of the opening. This protrusion 210 rests on the two projections 62 when a transport unit 40 is loaded.

In the exemplary embodiment shown, the carrier device 60 is designed as a hollow profile which may be cost-effectively produced from aluminum, for example. For the projections 62, separate profile strips are provided which are joined to the hollow profile, for example screwed, adhesively bonded, or connected in a form-fit manner.

The projection strips 62 may be made, for example, of HDPE, PP, or PTFE, or some other material having low sliding friction. Since only the projection strips are subjected to mechanical wear during operation, easy replacement is advantageous.

Alternatively, the carrier device may have a one-part design or may be divided into even further parts. For example, the individual carrier channels may be manufactured as one part, for example from fiber-reinforced plastic material, and connected to a shared carrier plate in order to form the carrier device.

In the exemplary embodiment shown, one end of the carrier channel 61 is permanently closed with a stop element 63 that prevents the bottles 203, 200 from falling out.

The loading of the carrier device takes place via the opposite opening in the carrier channel. The bottles 203, 200 may be introduced into the carrier channels by sliding, for example, with the protrusion 210 sliding on the projections. To prevent the transport goods 200 from falling out after the transport unit is loaded, the filling opening of the transport channels 61 is reversibly closed with a closure element 64. In the example shown, the closure element is designed as an elastic spring tongue element 64 whose tongue closes the carrier channel 61 in a form-fit manner. For loading, the spring tongue is lifted so that the filling opening is exposed. After loading is complete, the tongue is released and returns to its closed position. An analogous procedure is carried out for unloading.

Alternatively, both sides of the carrier channel may be reversibly closed with a closure element. This allows, for example, loading and unloading of the transport unit from both sides.

The present invention is not to be limited in scope by the specific embodiments described herein. Indeed, various modifications of the present invention, in addition to those described herein, will be apparent to those skilled in the art from the foregoing description and accompanying drawings. Thus, such modifications are intended to fall within the scope of the appended claims. Additionally, various references are cited throughout the specification, the disclosures of which are each incorporated herein by reference in their entirety.

It is claimed:

1. A buffer storage device (100) for an overhead conveyor system (10) having individually conveyable transport units (40), comprising:
a closed conveying path comprising a buffer section (117) along which transport units are conveyable downstream;
a feed section (104) for feeding transport units to a feed point (102) of the buffer section;
a discharge section (105) for discharging transport units from a discharge point (103) of the buffer section; and
one or more additional bypass sections (113) which in each case connect a starting point along the buffer section to a destination point along the buffer section.

2. The buffer storage device according to claim 1, wherein a bypass section forms a return section (110), which together with the buffer section (117) forms the closed conveying path.

3. The buffer storage device according to claim 2, wherein one or more bypass sections (113) are designed as ascending sections (111, 111a, 111b) that connect the starting point of the bypass section to a destination point of the bypass section situated upstream from the stated starting point.

4. The buffer storage device according to claim 2, wherein one or more bypass sections (113) are designed as drop sections (120, 120a) that connect the starting point of the bypass section to a destination point of the bypass section situated downstream from the stated starting point.

5. The buffer storage device according to claim 1, wherein the buffer storage device (100) has two or more feed sections (104, 104′, 104″, 104a-104d) for feeding transport units.

6. The buffer storage device according to claim 5, wherein the two or more feed sections (104, 104′, 104″, 104a-104d) discharge into the buffer section (117) at two or more feed points (102, 102a-102d).

7. The buffer storage device according to claim 1, wherein the buffer storage device (100) has two or more discharge sections (105, 105′, 105″, 105a) for discharging transport units.

8. The buffer storage device according to claim 7, wherein the two or more discharge sections (105, 105′, 105″, 105a) branch off from the buffer section (117) at two or more discharge points (103, 103a).

9. The buffer storage device according to claim 1, wherein the entire buffer section (117) or a portion of the buffer section has a downward slope.

10. The buffer storage device according to claim 1, wherein the transport units (40) are conveyable by the force of gravity along the entire buffer section (117) or a portion of the buffer section.

11. The buffer storage device according to claim 1, wherein the transport units (40) are conveyable by a drive, for example a power and free conveyor or a circulating conveyor, on the entire buffer section (117) or a portion of the buffer section.

12. The buffer storage device according to claim 1, wherein the entire buffer section (117) or a portion of the buffer section has the form of a downwardly leading conveying path.

13. The buffer storage device according to claim 1, wherein one or more accumulation points (106, 106a-106g) at which transport units (40) may be accumulated and released in a selective manner are provided along the buffer section (117).

14. The buffer storage device according to claim 1, wherein a storage ring device (130) is provided along the conveying path of the buffer storage device (100), wherein said storage ring device can take transport units (40) from the buffer storage device at a transfer point and store them, then withdraw them and transfer them to the transfer point of the buffer storage device.

15. The buffer storage device according to claim 1, wherein a sorting device is provided along the conveying path of the buffer storage device (100), wherein the sorting device takes transport units (40) from the buffer storage device, sorts the transport units (40), and transfers the transport units (40) back to the buffer storage device in an altered sequence.

16. The buffer storage device according to claim 1, wherein the buffer storage device (100) includes a locating system, for example a radio-based locating system, with which a location of transport units (40) and/or transport goods (200) within the buffer storage device may be determined.

17. The buffer storage device according to claim 1, wherein the buffer storage device (100) includes a monitoring system with one or more sensor units situated along the conveying path, via which data of data carrier elements of passing transport units (40) and/or passing transport goods (200) may be received.

18. A buffer storage system (100a) having two or more buffer storage devices (100) according to claim 1, connected in parallel.

19. The buffer storage system (100a) according to claim 18, wherein connecting sections are provided between two or more buffer storage devices (100) connected in parallel, and wherein transport units (40) can change from one buffer storage device to another buffer storage device, via said connecting sections.

20. An overhead conveyor system (10) having a buffer storage device (100) according to claim 1.

21. The overhead conveyor system according to claim 20, having a sorting device situated downstream from the buffer storage device (100).

22. An overhead conveyor system (10) having a buffer storage system (100a) according to claim 18.

23. The overhead conveyor system according to claim 22, having a sorting device situated downstream from the buffer storage system (100a), respectively.
